(19) United States
(12) Patent Application Publication
(10) Pub. No.: US 2006/0272127 A1
(43) Pub. Date: Dec. 7, 2006

(54) Continuously positioned hinge

(75) Inventor: Jih-Chin Chen, Shin-Juang City (TW)

Correspondence Address: HDSL, 4331 STEVENS BATTLE LANE, FAIRFAX, VA, 22033, US

(73) Assignee: Ray Home Precision Industrial Co., Ltd.

(21) Appl. No.: 11/144,681

(22) Filed: Jun. 6, 2005

(51) Int. Cl. E05D 11/08

(52) U.S. Cl. 16/340

(57) ABSTRACT

A continuously positioned hinge, which is installed between the main body and the display unit of an electron device, includes a rotational base, a positioning base and at least an elastic friction element. The rotational base includes a through hole, while the positional base includes a connection portion. The connection portion is penetrated through the through hole of the rotational base. The elastic friction element is connected to the connection portion of the positioning base, and sandwiched and compressed between the rotational base and the positioning base. The elastic friction element further includes a first ring and a second ring, which are made of different metallic materials. In this, manner, the elastic structure of the hinge becomes more durable and the service life becomes longer. Furthermore, the overall structures of the hinge is simplified and the size is largely reduced.

### BACKGROUND OF THE INVENTION

The present invention relates generally to a continuously positioned hinge, and more particularly to a continuously positioned hinge that is disposed on an electronic apparatus.

Most of the modern electronic apparatus, such as digital camera, laptop computer and hand-held computer, include a display device for displaying information from the electronic devices. In order to enhance the convenience of usage, the electronic apparatus having a day device often include a hinge connecting the main body of the electronic apparatus and the display device. Such a hinge enables the display device to rotate about the main body and to adjust the angle between the main body and the display device according to the user's preference. Therefore, it is important to develop a hinge that can continuously position the angle between the display device and the main body.

Referring to FIG. 1 and FIG. 2, a conventional continuously positioned hinge is illustrated. As shown, the hinge 1a includes a rotational base 10a, a positioning base 20a and two disk-like elastic foils 30a. The positioning base 20a is penetrated through the rotational base 10a and the disk-like elastic foils 30a. A plurality of washers is disposed between the disk-like elastic foils 30a and the positioning base 20a, the rotational base 10a and the nut. By employing the elastic force from the compressed disk-like elastic foils 30a, the positioning angle formed between the rotational base 10a and the positioning base 20 is thus restricted.

However, in the conventional continuously positioned hinge, the disk-like elastic foils 30a of the hinge 1a will be worn away after some time. Therefore, it is difficult to keep a fixed angle between the rotational base 10a and the positioning base 20a. In addition, the elastic force of the disk-like elastic foils 30a is formed from its reverse stacked configuration. Consequently, the length of the hinge 1a can not be reduced significantly to fit into the smaller and smaller electronic apparatus. Moreover, since the; hinge 1a contains many component parts, it is therefore difficult to reduce the production cost.

In light of the above, the inventor of the present invention has developed a new continuously positioned hinge so as to solve the problems set forth above.

### BRIEF SUMMARY OF THE INVENTION

The present invention is to provide a continuously positioned hinge. The hinge employs the material properties of two different metals to generate elastic force and carbon lubrication between the ring structures. Therefore, the hinge of the present invention is more durable, which can prolong its service life. Moreover, the structure of the hinge is simplified, and the size is largely reduced.

In order to achieve the above and other objectives, the continuously positioned hinge of the present invention, which is installed between the main body and the display unit of an electron device, includes a rotational base, a positioning base and at least an elastic friction element The rotational base includes a through hole, while the positions base includes a connection portion. The connection portion is penetrated through the hole of the rotational base. The elastic friction element is connected to the connection portion of the positioning base, and sandwiched and compressed between the rotational base and the positioning base. The elastic friction element further includes a first ring and a second ring, which are made of different metallic materials. Therefore, the above objectives are achieved.

### BRIEF DESCRIPTION OF THE DRAWINGS

FIG. 1 is a perspective view of a conventional hinge.

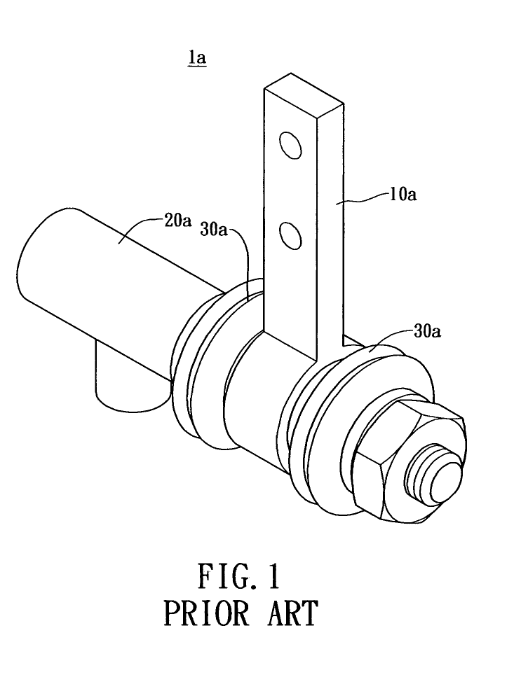

FIG. 2 is a sectional view of the conventional hinge.

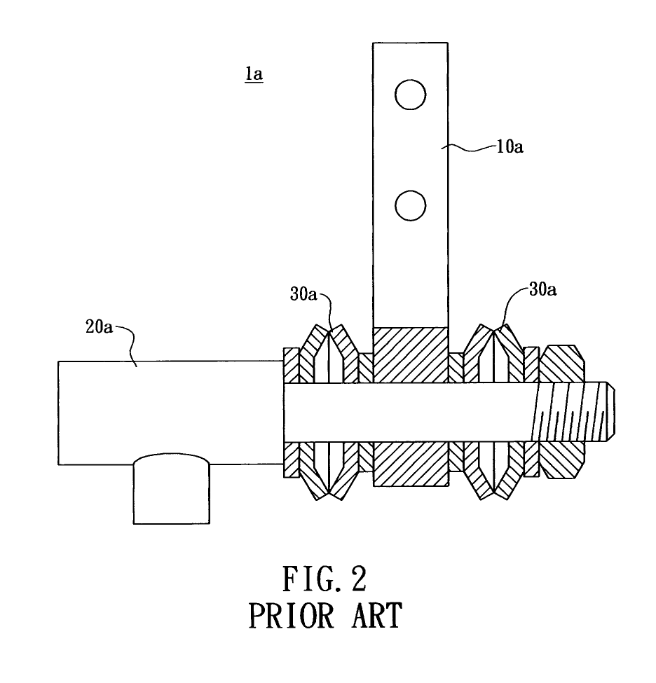

FIG. 3 is an explosive view of a continuously positioned hinge in accordance with the first embodiment of the present invention.

FIG. 4 is a perspective view of the continuously positioned hinge in accordance with the first embodiment of the present invention.

FIG. 5 is a sectional view of the continuously positioned hinge in accordance with the first embodiment of the present invention.

FIG. 6 illustrates the continuously positioned hinge of the present invention in combination with a laptop computer.

FIG. 7 is an explosive view of a continuously positioned hinge in accordance to with the second embodiment of the present invention.

FIG. 8 is a sectional view of the continuously positioned hinge in accordance with the second embodiment of the present invention.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

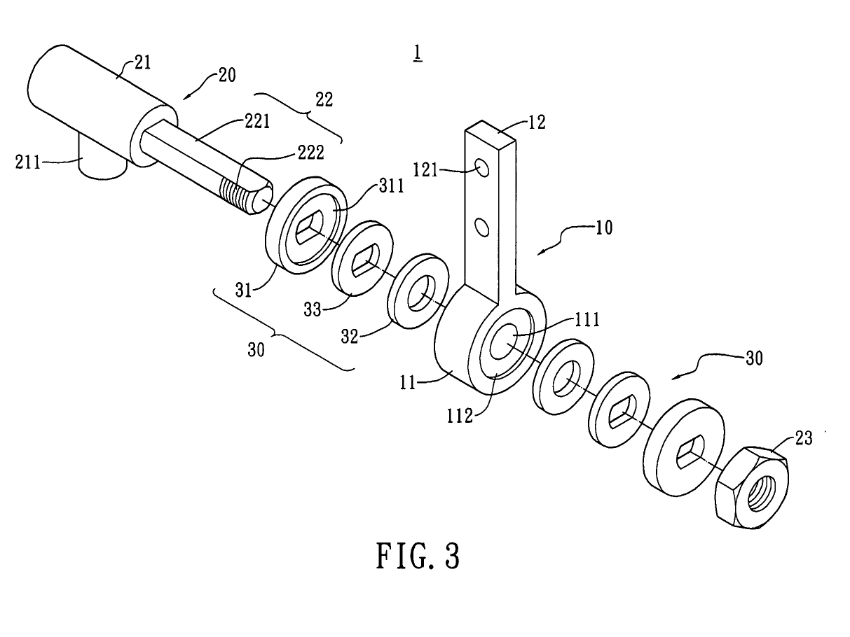

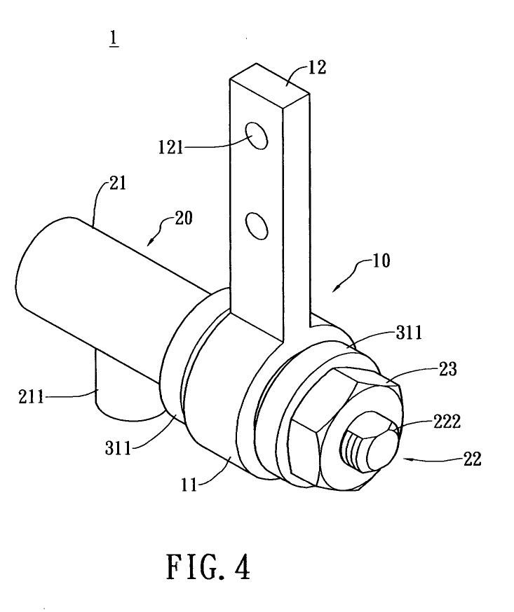

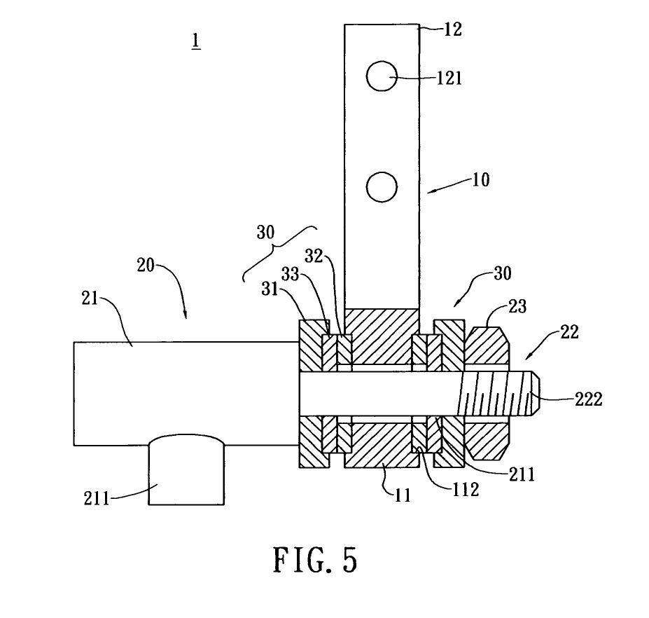

Referring to FIG. 3, FIG. 4 and FIG. 5, an explosive view, a perspective view and a sectional view of the present invention are illustrated. The present invention provides a continuously positioned hinge. The hinge 1 includes a rotational base 10, a positioning base 20 and at least an elastic friction element 30.

The rotational base 10 includes a circular ring 11 and a branch arm 12 extended outward from the circular ring 11. A through hole 111 is formed at the central portion of the circular ring 11. A circular sagged area 112 is formed respectively on the left and right face of the circular ring 11 concentric to the through hole 111. The branch arm 12 is a rectangular piece, which includes two penetrative holes 121 formed thereon.

The positioning base 20 includes a pillar 21 and a connection portion 22. The diameter of the pillar 21 is larger than the diameter of the connection portion 22. A linkage element 211 is formed on the pillar 21 extending downward. At the center of the linkage element 211, a sunken hole is formed. The connection portion 22 can be an pivotal shaft 221 horizontally extended from one end of the pillar 21. Or, the connection portion 22 can be a threaded hole formed at the central portion of the pillar 21 and a bolt fastened with the threaded hole (not shown). In this particular embodiment, the connection portion 22 is an pivotal shaft, which is connected to the through hole 111 of the rotational base 10. The end of the pivotal shaft 221 includes a outer thread 222. The outer thread 222 provides fastening elements such as the nut 23 to screw thereon. In addition, a positioning surface is formed above and beneath, the pivotal shaft 221 and the outer thread 222.

The elastic friction element 30 is thrust on the connection portion 22 of the positioning base 20, and is in a one-set: or a two-set form. If the elastic friction element 33 is in a one-set form, it can be sandwiched and compressed between the rotational base 10 and the positioning base 20, or sandwiched and compressed between the rotational base 10 and the nut 23 described above. In this particular embodiment, the elastic friction element 30 is in a two-set form, one set of which is sandwiched and compressed between the rotational base 10 and the positioning base 20, while the other set is sandwiched and compressed between the rotational base 10 and the nut 23 described above. The elastic friction element 30 includes a first ring 31 contacting the pillar 21, a second ring 32 closely attached to the sagged area 112 of the circular ring 11, and a third ring 33 disposed between the first ring 31 and the second ring 32 The first ring 31 includes a circular retaining area 311. The retaining area 311 provides the third ring 33 to be disposed therein. Both the center of the first ring 31 and that of the third ring 33 include a groove hole corresponding to the positioning surface of the pivotal shaft 221. The surface of the first ring 31 is less hard than those of the second ring 32 and the third ring 33. Each ring 31, 32, 33 is made of metallic materials, whereas the first ring is made of soft metals such as copper or copper alloy, while the second ring 32 and the third ring 33 are made of tungsten steel. The first ring 32 generates elastic force from compression so as to actuate the rotational base 10 and the positioning base 20. On the other hand, the compression of the second ring 32 and the third ring 33 generates carbon lubrication effect. In this manner, the hinge 1 has a very durable elastic structure, which can prolong the service life.

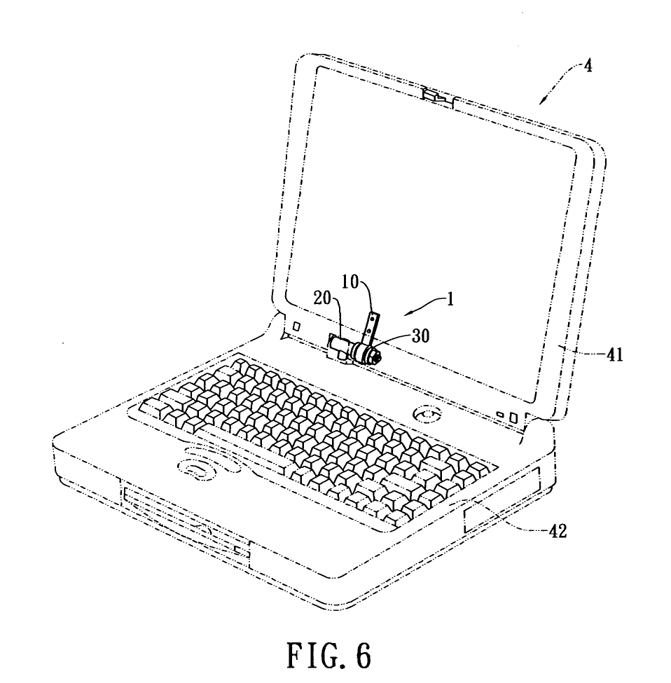

Referring to FIG. 6, the continuously positioned hinge of the present invention in combination with a laptop computer is illustrated. The hinge of the present invention can also be disposed on a digital camera, a notebook computer, a liquid crystal display, a palm optical disk device, or other electronic apparatus. In this particular embodiment, the hinge is installed on a laptop computer 4. The laptop computer includes a display unit 41 and a main body 42. The penetrating holes 121 of the branch arm 12 is securely fastened to the display unit 41 by using some screws, while the linkage element 211 of the pillar 21 is thrust to the fastening pillar (not shown) of the main body 42. When the display unit 41 is flipped up, the rotational base 10 is driven to rotate about the pivotal shaft 221 of the positioning base 20. Due to the material property of the first ring 31, it can generate elastic force when it is sandwiched and compressed. The second ring 32 and the third ring 33 will generate, carbon lubrication effect after they are compressed. This can largely extend the service life of the hinge 1. It is noted that the rings 31, 32, 33 are in a flat plate form. Also, the second ring 32 is partly retained in the sagged area 112 of the rotational base 10, while the third ring 33 is partly retained in the retaining area 211 of the first ring 31. Therefore, the overall size of the hinge 1 is largely reduced.

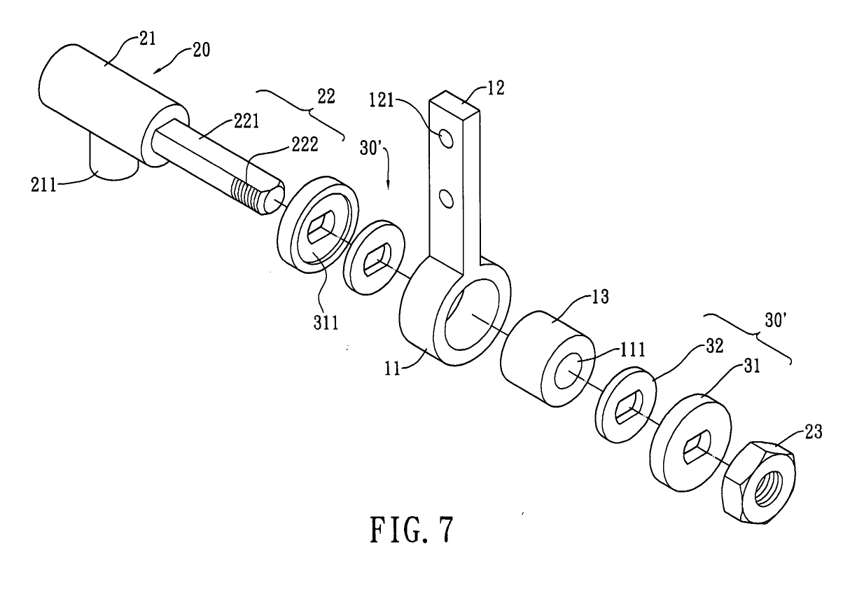

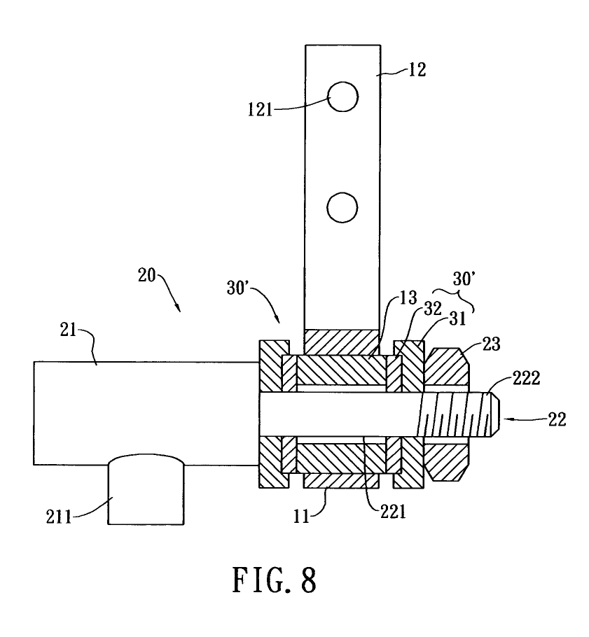

Referring to FIG. 7 and FIG. 8, an explosive view and a sectional view of the continuously positioned hinge in accordance with the second embodiment of the present invention are illustrated. In this particular embodiment, the hinge 1 of the present invention includes a bushing 13 tightly disposed in the circular ring 11 of the rotational base 10. The bushing 13 includes a through hole 111 formed at the center thereof. The left and right surfaces of the bushing 131 protrude out of the circular ring 11. The elastic friction element 30′ is composed of a first ring 31 and a second ring 32. The surface of the first ring 31 is less hard than that of the second ring 32. The retaining area 331 provides the second ring 32 to dispose therein. The friction surface is thus formed between the end surfaces of the second ring 32 and the bushing 13. In this manner, the same function as of the first embodiment is also achieved, while the structure of the hinge 1 is further simplified.

In summary, the continuously positioned hinge of the present invention indeed satisfies the utility, novelty and non-obviousness requirements of the patent law, a grant of letters patent is thus respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A continuously positioned hinge comprising:
a rotational base having a through hole;
a positional base having a connection portion, the connection portion being penetrated through the through hole of the rotational base; and
at least an elastic friction element connected to the connection portion of the positioning base, and sandwiched and compressed between the rotational base and the positioning base, the elastic friction element further comprising a first ring and a second ring, which are made of different metallic materials.

2. The hinge as recited in claim 1, wherein the positioning base comprises a pillar, the connection portion being a pivotal shaft horizontally extended from one end of the pillar.

3. The hinge as recited in claim 2, wherein one end of the pivotal shaft comprises an outer thread formed thereon, thereby fastening with a nut.

4. The hinge as recited in claim 3, wherein the elastic friction element is of a two-set form, the other set being disposed between the rotational base and the nut.

5. The hinge as recited in claim 1, wherein the connection portion comprises a threaded hole formed on the positioning base and a threaded pillar securely fastened to the threaded hole.

6. The; hinge as recited in claim 1, wherein the first ring comprises a retaining area, the retaining area providing the second ring to be disposed therein.

7. The hinge as recited in claim 1, wherein the elastic friction element further comprises a third ring, the third ring being disposed between the first ring and the second ring.

8. The hinge as recited in claim 7, wherein the surface of the first ring is less hard than that, of the second ring and the third ring.

9. The hinge as recited in claim 8, wherein the first ring is made of a soft metal, such as copper and copper alloy.

10. The hinge as recited in claim 8, wherein the second ring and the third ring are made of tungsten steel.

11. The hinge as recited in claim 7, wherein the first ring comprises a retaining area, the retaining area providing the third ring to be disposed therein.

12. The hinge as recited in claim 1, wherein the rotational base is connected to a bushing, the bushing having a through hole formed at the center thereof.

13. A continuously positioned hinge, comprising:
a rotational base having a through hole;
a positional base having a connection portion, the connection portion being penetrated through the through hole of the rotational base; and
at least an elastic friction element connected to the connection portion of the positioning base, and sandwiched and compressed at one side of the rotational base, the elastic friction element further comprising a first ring and a second ring, which are made of different metallic materials.
